(19) United States
(12) Patent Application Publication
(10) Pub. No.: US 2025/0062108 A1
(43) Pub. Date: Feb. 20, 2025

(54) CALIBRATING A MASS SPECTROMETER

(71) Applicant: Thermo Fisher Scientific (Bremen) GmbH, Bremen (DE)

(72) Inventor: Hans-Juergen Schlueter, Bremen (DE)

(73) Assignee: Thermo Fisher Scientific (Bremen) GmbH, Bremen (DE)

(21) Appl. No.: 18/721,562

(22) PCT Filed: Dec. 16, 2022
(86) PCT No.: PCT/EP2022/086365

§ 371 Date: Jun. 18, 2024

(30) Foreign Application Priority Data
Dec. 21, 2021 (GB) 2118625.9

(51) Int. Cl. H01J 49/00; H01J 49/02

(52) U.S. Cl. CPC H01J 49/0009; H01J 49/0031; H01J 49/025

(57) ABSTRACT

A method of calibrating a mass spectrometer is disclosed, the mass spectrometer comprising at least one ion detector of a first type having a first ion intensity measurement range (IDR1) and at least one ion detector of a second type having a second ion intensity measurement range (IDR2). The first ion intensity measurement range and the second ion intensity measurement range share an overlap range (IDR0). The method may comprise: —detecting a wash period (WP), —measuring, during and/or following a wash period, an ion intensity using both at least one ion detector of a first type and at least one ion detector of a second type to produce a first measured ion intensity and a second measured ion intensity respectively, and —using the first measured ion intensity and a second measured ion intensity to determine a detector calibration factor.

### FIELD OF THE INVENTION

The invention relates to calibrating a spectrometer, such as a mass spectrometer. More in particular, the invention relates to calibrating a mass spectrometer having at least two types of ion detection modes with different detection ranges.

### BACKGROUND OF THE INVENTION

Mass spectrometers may utilize more than one type of ion detectors and/or ion detection modes for detecting ions. Mass spectrometers using a plasma ion source, such as an inductively coupled plasma (ICP) source, may have a counting ion detection mode, an analog ion detection mode and a Faraday ion detection mode. In the counting mode, individual ions are counted, while in the analog mode, the impacting ions cause an electric current which is measured. In the Faraday mode a current is measured too.

U.S. Pat. No. 5,463,219 discloses a mass analyzer system having a simultaneous mode electron multiplier detector which outputs both a pulse count and an analog signal. Depending on the ion flux intensity, the signals define a pulse count only region in which the pulse count only signal is valid, an overlap region in which both the pulse count and analog signals are valid, an analog signal only region in which only the analog signal is valid, and a neither analog nor pulse region in which neither signal is valid.

Having multiple detection regions can increase the dynamic range of the detection and can improve the accuracy of the ion detection in certain ranges, but only if the different ion detector types are calibrated relative to each other. That is, the detection result should be independent of the detector type or detector mode used, and detections of different types should be compared to adjust the detection results, if necessary. In order to be able to compare ion detections of different types, at least some ion detections should take place in the overlap region where at least two detector types or detection modes can be used. Thus, the use of multiple ion detector types during a single measurement introduces the problem of producing an ion intensity which lies in the overlap region when a calibration is to be carried out.

It is known to use special calibration procedures with special calibration solutions to bring the ion intensity in the calibration (that is, overlap) range. Those special calibration solutions cause the spectrometer to produce ion intensities in the overlap range. However, the use of special calibration solutions increases the operating costs of the spectrometer while reducing the time it can be used effectively. Using special calibration solutions also requires additional analyzer time. In practice, this causes the calibration to be carried out less often, which may lead to outdated calibrations and hence incorrect measurements.

### SUMMARY OF THE INVENTION

The invention solves these and other problems by providing a method of calibrating a mass spectrometer, which mass spectrometer comprises at least one ion detector of a first type having a first ion intensity measurement range and at least one ion detector of a second type having a second ion intensity measurement range, the first ion intensity measurement range and the second ion intensity measurement range sharing an overlap range. In accordance with the invention, the method may comprise:
detecting a wash period,
measuring, during and/or following a wash period, an ion intensity using at least one ion detector of a first type and at least one ion detector of a second type to produce a first measured ion intensity and a second measured ion intensity respectively, and
using the first measured ion intensity and a second measured ion intensity to determine a detector calibration factor.

By measuring ion intensities during and/or following a wash period, there is a significantly increased chance that an ion intensity can be measured in the overlap range of the detector types, thus allowing a calibration of the detectors.

In certain embodiments, the ion intensities may be measured during the wash period only. In other embodiments, the ion intensities may be measured after the wash period only, typically in a time period immediately following the wash period. In some embodiments, the ion intensities may be measured during and after the wash period. The time period following the wash period, in which time period calibration measurements can be carried out, may be referred to as measurement period or recovery period. Such a measurement period may have a limited time duration, for example limited a duration which may be equal to the duration of the wash period or having a similar duration. A wash period may have a duration of several seconds (e.g. 10 to 30 seconds) or several minutes (e.g. 1 to 5 minutes, for example 1, 2 or 3 minutes).

The two ion detector types have different but overlapping detection ranges. The two detection ranges may together constitute a total ion intensity measurement range. It will be understood that a mass spectrometer may comprise more than two, for example three, detector types having different but overlapping detection ranges. The detectors of a first and second type may be similar in design but may have different detection ranges. For example, a SEM detector of a first type may have a first detection range, while a SEM detector of a second type may have a different detection range.

It is noted that the detection range of an ion detector is the operational or effective detection range. Some detectors, in particular some analog detectors, may have a range in which they are capable of detecting which is larger than the operational detection range in which they are used. Detections outside the operational or effective detection range are typically less accurate.

In an embodiment, detecting the wash period comprises detecting a wash signal to control an autosampler. That is, a wash signal supplied to an autosampler, which may cause the autosampler to use a wash fluid instead of a sample fluid, may be used to detect a wash period and to then carry out calibration measurements.

In an embodiment, detecting the wash period comprises detecting an ion intensity approaching zero. That is, previous ion intensity measurements indicating that the ion intensity approaches zero may be used to detect a wash period. It is noted that the ion intensity approaching zero may in practice be determined by detecting ion intensities below a threshold. Such a threshold may, for example, be 10% of the lowest ion detection range, if the lowest detecting range includes approximately zero ion intensities. In embodiments in which the lowest detection range does not include approximately zero ion intensities, the threshold value may be the lowest detection value of the lowest detecting range.

In an embodiment, detecting the wash period may comprise first measuring an ion intensity higher than or within the overlap range and then an ion intensity lower than the overlap range. That is, an ion intensity which was first higher than the overlap range and subsequently lower than the overlap range may be used as an indicator of a wash period, and hence of a suitable range for a calibration measurement. Additionally, or alternatively, an ion intensity which was within the overlap range and subsequently lower than the overlap range may be used as an indicator of a wash period, and hence of a suitable range for a calibration measurement.

In an embodiment, detecting a wash period may comprise detecting whether:
a first measured ion intensity of the sequence is within the first ion intensity measurement range only,
a second measured ion intensity of the sequence is within the overlap range, and
a third measured ion intensity of the sequence is within the third ion intensity measurement range only.

In an embodiment, measuring the ion intensity using the at least one ion detector of the first type and the at least one ion detector of the second type to produce the first measured ion intensity and the second measured ion intensity is carried out during a measurement or recovery period immediately following the wash period. The term recovery period may be used as the ion intensity typically increases, that is, recovers, after having been low during the wash period.

In an embodiment, the recovery or measurement period has approximately the same duration as the wash period. In an embodiment, the recovery or measurement period has a length of between 1 and 100 seconds, preferably between 2 and 50 seconds, more preferably between 5 and 10 seconds.

In an embodiment, the method further comprises measuring, during and/or following a wash period, an ion intensity using at least one ion detector of a first type and at least one ion detector of a second type at least two times per detector type and interpolating measurement results per detector type.

In an embodiment, the steps are carried out repeatedly, preferably as often as possible, so as to update the calibration as often as possible.

In general, the invention provides a method of calibrating a mass spectrometer by detecting an increasing or a decreasing ion intensity and measuring the ion intensity at least once, but optionally at least twice, in an overlap range of the detector measurement ranges. The measured ion intensity in the overlap range may serve for the calibration, while the measured ion intensity in a first ion intensity measurement range excluding the overlap range and in a second ion intensity measurement range excluding the overlap range may serve to determine whether the ion intensity is increasing or decreasing. A first measured ion intensity may thus be within the first ion intensity measurement range only, a second measured ion intensity of the sequence may be within the overlap range, and a third measured ion intensity of the sequence may be within the third ion intensity measurement range only. Detecting a decreasing or increasing intensity by using the first, the second and the third measured ion intensity may indicate a wash period but may additionally or alternatively indicate another cause.

The invention also provides a method of operating a mass spectrometer comprising at least one ion detector of a first type having a first ion intensity measurement range and at least one ion detector of a second type having a second ion intensity measurement range, wherein the first ion intensity measurement range and the second ion intensity measurement range share an overlap range, the method comprising:
measuring a sequence of ion intensities,
detecting whether:
   a first measured ion intensity of the sequence is within the first ion intensity measurement range only,
   a second measured ion intensity of the sequence is within the overlap range, and
   a third measured ion intensity of the sequence is within the third ion intensity measurement range only, and
determining a calibration factor using the second measured ion intensity.

This embodiment allows automatic detection of the ion intensity being the overlap range, not only during or after wash periods but also when samples having very different ion intensities are being measured. The second measured ion intensity is measured after the first measured ion intensity, but not necessarily immediately after. Similarly, the third measured ion intensity is measured after the second measured ion intensity, but not necessarily immediately after. The first, second and third ion intensities may thus be measured consecutively. As the second measured ion intensity is within the overlap range, it can be measured by both an ion detector of a first type and an ion detector of a second type, thus enabling a calibration of the detector types.

The invention additionally provides a method of operating a mass spectrometer comprising ion detectors, the method comprising:
feeding a first sample into the spectrometer and measuring a first ion intensity,
washing the mass spectrometer by feeding a washing fluid into the spectrometer,
feeding a second sample into the spectrometer and measuring a second ion intensity, and calibrating the spectrometer, using the first ion intensity and the second ion intensity, during and/or after the washing.

This embodiment also allows the calibration to be carried out automatically. The first and second ion intensities can be measured consecutively.

The invention further provides a software program product comprising instructions which allow a controller of a mass spectrometer to carry out any of the methods defined above.

The invention also provides a controller for a mass spectrometer, the controller being configured to perform any of the methods described above. The invention additionally provides a mass spectrometer comprising such a controller. A mass spectrometer according to the invention may further comprise at least one of an ion source, one or more ion lenses, one or more Wien filters, one or more collision cells, one or more mass filters, one or more ion traps, one or more magnetic sector elements, one or more detectors and one or more data processing units. The mass filters may be multipole mass filters, such as quadrupole mass filters. The mass spectrometer may be provided with a sampling system and a nebulizer.

### BRIEF DESCRIPTION OF THE DRAWINGS

FIG. 1 schematically shows a mass spectrometer system in which the invention may be utilized.

FIG. 2A-2D schematically show examples of calibration measurements according to the invention.

FIG. 3 schematically shows an autosampler system which may be used in the invention.

### DETAILED DESCRIPTION OF EMBODIMENTS

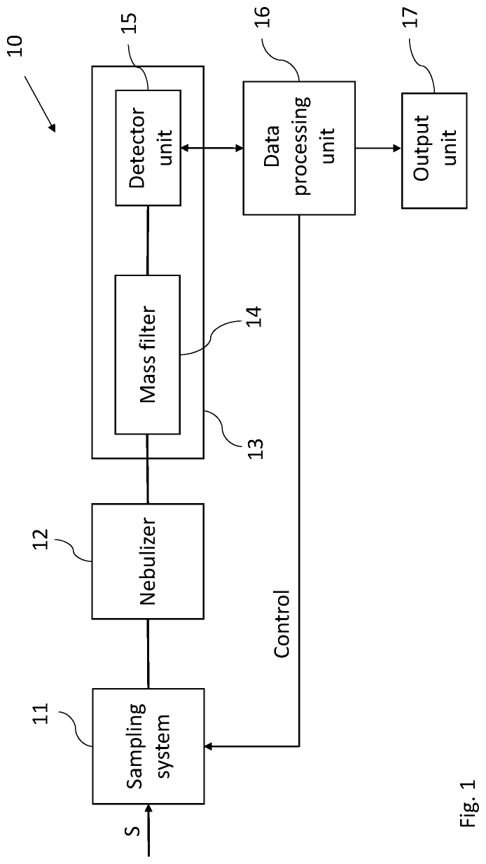

An exemplary embodiment of a mass spectrometer system in which the invention may be utilized is schematically illustrated in FIG. 1. The mass spectrometer system 10 is shown to comprise a sampling system 11, a nebulizer 12, a mass analyzer 13, a data processing unit 16 and an output unit 17. The mass analyzer 13 is shown to comprise a mass filter 14 and a detector unit 15.

The sampling system 11 may, for example, comprise an autosampler for receiving samples S. The samples may be supplied, via a sample transfer line, to a nebulizer 12 or another sample-to-aerosol converter. The nebulizer 12 may be provided with a spray chamber (not shown). The aerosol produced in the sample-to-aerosol converter is transferred to the mass analyzer 13. The mass filter 14 of the mass analyzer 13 may comprise a multipole filter, such as a quadrupole filter, and/or a magnetic sector unit, for example. A magnetic sector unit may also be referred to as a mass separating unit, as ions having different mass/charge ratios are separated in space. The mass filtered ions are detected by the detector unit 15 and result in detection signals, which are supplied to the data processing unit 16.

The data processing unit 16 can process the detector signals and output relevant data to the output unit 17, which may comprise a display unit. The data processing unit 16 may comprise a controller for controlling other units, such as the sampling system 11.

The detector unit 15 can comprise at least two different detectors or modes of using a detector. A secondary electron detector (SEM), for example, can produce electrons in response to the impact of ions, which electrons can then be multiplied to improve the detection. A secondary electron detector typically contains a plurality of dynodes. The electrical current through a first set of dynodes is measured as an analog signal, either at the dynodes or at a Faraday cup. Part or all of the electrical current after this first set of dynodes is further amplified by a second set of dynodes. If the ion current is small enough (that is, if the time interval between ions impacting upon the detector is large enough), the signal at the end of the second set of dynodes consists of electrical current pulses, which can be counted using suitable electronics. This results in two detection ranges: a so-called analog range and a so-called counting range, which ranges typically show overlap. There may be a third detection range in which the ion current is measured without amplification by a set of dynodes, typically by using a Faraday collector. This range may be referred to as Faraday range.

The amplification factor of the sets of dynodes, especially the one of the first set of dynodes drifts when the detector ages, but also slightly changes by interaction with residual gas particles within the analyser. Therefore, these different detectors and/or detection modes need to be cross-calibrated regularly, to ensure that ion intensity measurements carried out with different detectors or detector modes produce substantially the same results. Thus, ion intensity measurements have to be carried out with at least two different detectors (or detector modes) and their results should be compared to determine any calibration factor (which may be a factor with which a measured ion intensity of one type of detector has to be multiplied to obtain the same value as a measured ion intensity of another type of detector). This requires that the ion intensity to be measured is within the overlap range of the two (or more) detector types (or detector modes).

Conventionally, there are two solutions for this. Either the spectrometer operator waits until the ion intensity is in the overlap range and then starts a cross-correlation, or a special calibration sample is used which is known produce an ion intensity in the overlap range. The first approach has the disadvantage that it is difficult to determine beforehand when a measurement in the overlap range will take place. The second approach requires a special sample to be introduced, leading to additional cost and time delays.

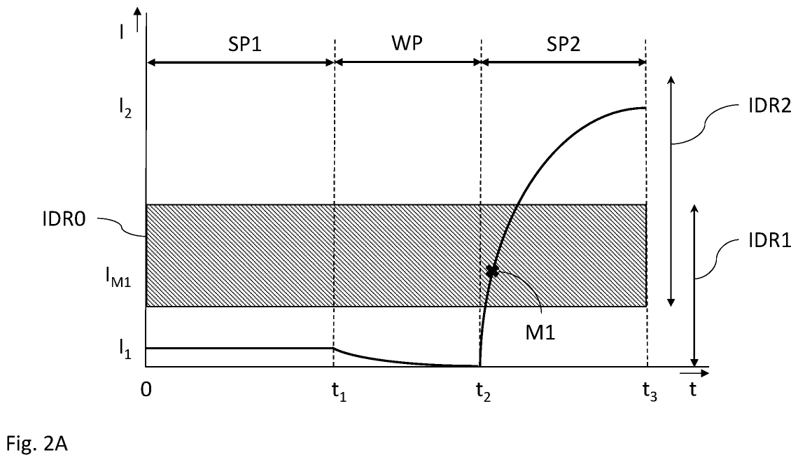

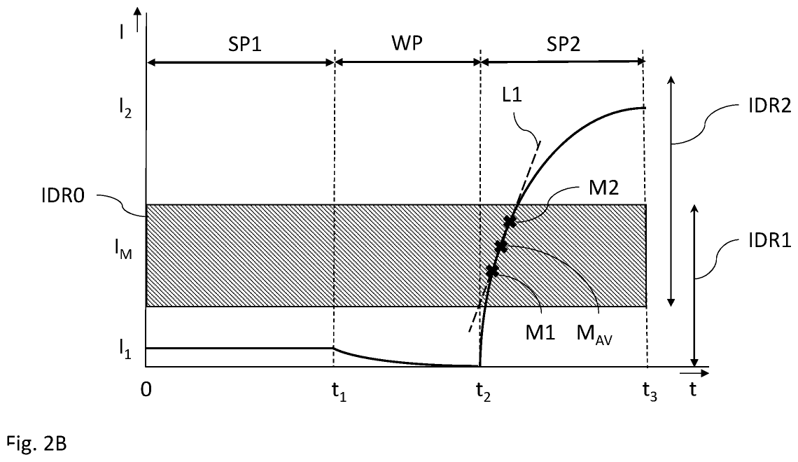

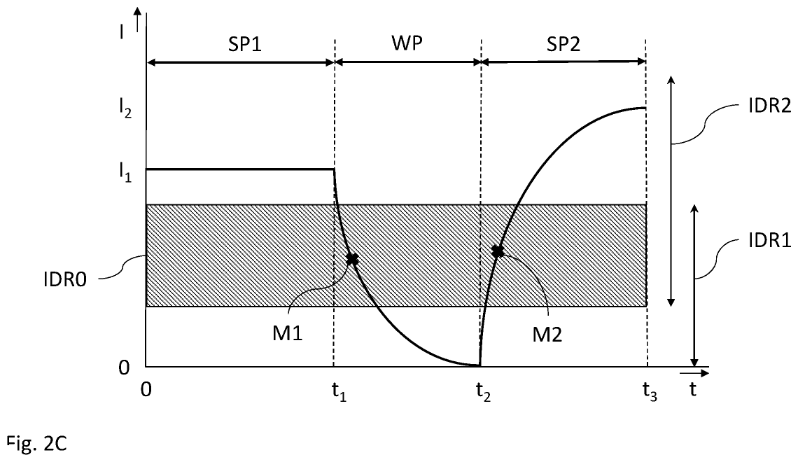

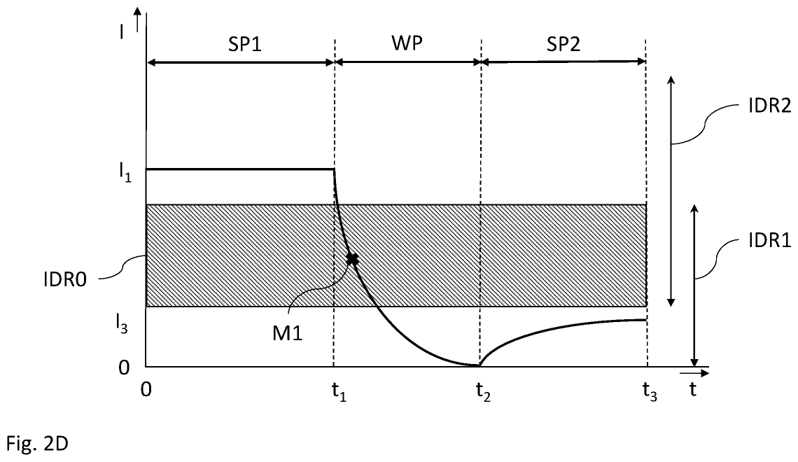

The invention provides a solution to this problem by utilizing the wash time between samples. When a number of samples have to be introduced after another into a spectrometer, a neutral (that is, typically analyte ion-free fluid) is introduced between those samples to avoid interference of the samples. Thus, after a first sample, a wash or flush fluid is introduced into the spectrometer. This wash fluid will typically result in an ion intensity equal to approximately zero. After the wash fluid has passed through the spectrometer, a second sample can be introduced. In accordance with the invention, the ion intensity transitions during and/or after the wash period are used for cross-calibration. This will further be explained with reference to FIGS. 2A-2D.

FIG. 2A schematically shows an ion intensity I as a function of the time t. The ion intensity is, in the example shown, measured with two detector types: a first detector type having an ion detection range IDR1 and a second detector type having an ion detection range IDR2. One, two, three or more detectors of each detector type may be used. It is noted that these ion detection ranges are the effective or operational detection ranges in which detectors of these types are used. Some detector types have a potential detection range that is larger than the effective detection range but are less accurate outside of the effective detection range.

The ion detection ranges IDR1 and IDR2 are different but share an overlapping detector range IDR0, which may also be referred to as overlap range. When the ion intensity is in the overlap range IDR0, the ion intensity can be measured with detectors of both types, which allows a cross-calibration to be made.

In accordance with the invention, this cross-correlation is made during and/or following the wash period. In the example of FIG. 2A, a first sample is processed by the spectrometer during the first sample period SP1 until the time t₁, resulting in an ion intensity I₁ which is within the first ion detection range IDR1 but not within the overlap range IDR0. At t₁, the wash period WP starts, during which a wash fluid passes through the spectrometer. As the wash fluid contains substantially no ions, the measured ion intensity will approximate zero. As not all of the first sample is immediately washed out, the measured ion intensity gradually decreases from I₁ to approximately zero. At t₂, the second sample is introduced into the spectrometer, resulting in an increase of the measured ion intensity to an intensity 12 during the second sample period SP2, that is, from t₂ to t₃. As the concentration of the second sample in the spectrometer rises gradually, the measured ion intensity also increases gradually, from approximately zero at t₂ to I₂ at t₃.

As the measured ion intensity increases after t₂, it passes through the overlap range IDR0, allowing a calibration measurement M1. Thus, the ion intensity I_{M1} of the measurement M1 can be measured with both detector types and the resulting two measured intensities can be used for detector calibration purposes. For example, a ratio of the two measured intensities can be used to correct the measurements of one type. In the example of FIG. 2A, only a single calibration measurement is shown, but as later will be explained with reference to FIG. 2B, two or more calibration measurements may be made when passing through the overlap range.

In the example of FIG. 2A, the measurement is made immediately following the introduction of the second sample into the spectrometer, so following t₂ and before t₃. That is, the measurement is made in a measurement period MP starting at the end of the wash period (which, in the present example, is identical to the beginning of the introduction of the second sample at t₂). This measurement period may end when the measured ion intensity has reached a maximum (that is, a plateau value) at t₃. As shown in FIG. 2A, the effective measurement period may be substantially shorter than MP.

The example of FIG. 2B is similar to the one of FIG. 2A, although in FIG. 2B there are two measurements M1 and M2 in the overlap region IDR0. This allows the calibration factor to be determined more accurately. In the example of FIG. 2B, the two measurements M1 and M2 are used to perform a linear interpolation using the line L1 to determine the averaged measurement M_{AV} with a corresponding ion intensity I_{M}. A linear interpolation can additionally, or alternatively, be used for more accurately determining the point in time at which the intensity is determined.

In the examples of FIGS. 2A & 2B, the first intensity I₁ was lower than the overlap region IDR0. In the example of FIGS. 2C, the first intensity I₁ is higher than the overlap region IDR0. As a result, a decreasing intensity during the wash period WP can be used for cross-calibration. As shown in FIG. 2C, when the intensity decreases from I₁ before time t₁ to approximately zero at time t₂, it passes through the overlap region IDR0, thus allowing a first cross-calibration measurement M1 to be made. When the intensity increases after the wash period WP from approximately zero to I₂, it passes through the overlap region IDR0 again, allowing a second cross-calibration measurement M2 to be made. It will be understood that each of measurements M1 and M2 in FIG. 2C could be carried out two or more times, thus allowing an interpolation to be made.

The example of FIG. 2D is similar to the one of FIG. 2A, although in the second sample period SP2 the ion intensity I does reach the overlap region IDR0. Instead, the ion intensity in the second sample period SP2 rises to a level 13 which lies exclusively in the first ion detection range IDR1.

In all examples, the wash period WP may be known a priori, be detected on the basis of the changes in the ion intensity or may be detected by another detector, for example an optical detector configured for optically detecting a wash liquid used during the wash period, and/or a flow sensor configured for detecting the flow of the washing liquid. The changes in ion intensity may include detecting whether:
a first measured ion intensity of the sequence is within the first ion intensity measurement range only,
a second measured ion intensity of the sequence is within the overlap range, and
a third measured ion intensity of the sequence is within the third ion intensity measurement range only.

Thus, the first, second and third measured ion intensities may be used as an indication that a wash period has occurred, and that the second measured ion intensity may be used for cross-calibration of the ion detectors.

The first, second and third ion measurements may be consecutive measurements, or at least the first measurement may precede the second measurement while the second measurement may precede the third measurement.

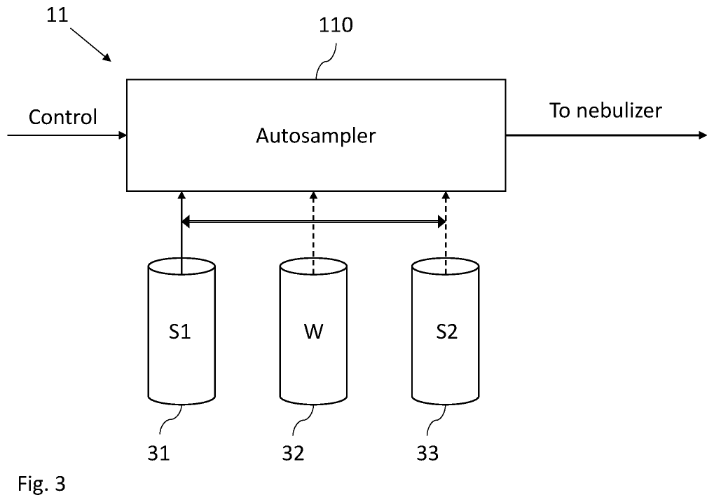

An exemplary embodiment of a sampling system 11 is schematically shown in FIG. 3. The sampling system 11 is shown to comprise an autosampler 110 which is arranged to take samples from three (or more) fluid containers 31, 32 and 33, such as vials. Fluid container 31 contains a first sample S1, fluid container 32 contains a washing fluid W, and fluid container 33 contains a second sample S1. By taking a fluid from one of these fluid containers at a time, the autosampler 110 can provide a selected fluid to the nebulizer (12 in FIG. 1).

It is noted that the autosampler 110 is arranged for supplying samples from different fluid containers to the nebulizer through the same sample transfer line. Some autosampler may comprise two or more parallel sample transfer lines for feeding samples and wash fluid to the nebulizer and may comprise a 6-way valve for switching between the sample transfer lines.

The autosampler 110 of FIG. 3 can be controlled by a control signal which indicates from which fluid container a sample is to be taken. The control signal can be produced by the data processing unit (16 in FIG. 1) of the mass spectrometer system. Alternatively, the control signal can be produced by a separate control unit.

It will be understood by those skilled in the art that the invention is not limited to the embodiments described above and that many additions and modifications may be made without departing from the scope of the invention as defined in the appending claims.

1. A method of calibrating a mass spectrometer comprising at least one ion detector of a first type having a first ion intensity measurement range and at least one ion detector of a second type having a second ion intensity measurement range, wherein the first ion intensity measurement range and the second ion intensity measurement range share an overlap range, the method comprising:
detecting a wash period,
measuring, during and/or following a wash period, an ion intensity using both at least one ion detector of a first type and at least one ion detector of a second type to produce a first measured ion intensity and a second measured ion intensity respectively, and
using the first measured ion intensity and a second measured ion intensity to determine a detector calibration factor.

2. The method according to claim 1, wherein detecting the wash period comprises detecting a wash signal to control an autosampler.

3. The method according to claim 1, wherein detecting the wash period comprises detecting an ion intensity approaching zero.

4. The method according to claim 1, wherein detecting the wash period comprises first measuring an ion intensity higher than the overlap range and then an ion intensity lower than the overlap range.

5. The method according to claim 1, wherein measuring the ion intensity using the at least one ion detector of the first type and the at least one ion detector of the second type to produce the first measured ion intensity and the second measured ion intensity is carried out during a recovery period immediately following the wash period.

6. The method according to claim 5, wherein the recovery period has approximately the same duration as the wash period.

7. The method according to claim 6, wherein the recovery period has a length of between 1 and 100 seconds.

8. The method according to claim 1, further comprising measuring, during and/or following a wash period, an ion intensity using at least one ion detector of a first type and at least one ion detector of a second type at least two times per detector type and interpolating measurement results per detector type.

9. The method according to claim 1, wherein the steps are carried out repeatedly.

10. A method of operating a mass spectrometer comprising at least one ion detector of a first type having a first ion intensity measurement range and at least one ion detector of a second type having a second ion intensity measurement range, wherein the first ion intensity measurement range and the second ion intensity measurement range share an overlap range, the method comprising:
measuring a sequence of ion intensities,
detecting whether: a first measured ion intensity of the sequence is within the first ion intensity measurement range only, a second measured ion intensity of the sequence is within the overlap range, and a third measured ion intensity of the sequence is within the third ion intensity measurement range only, and
determining a detector calibration factor using the second measured ion intensity.

11. A controller for a mass spectrometer, the controller being configured to perform a method comprising:
detecting a wash period,
measuring, during and/or following a wash period, an ion intensity using both at least one ion detector of a first type and at least one ion detector of a second type to produce a first measured ion intensity and a second measured ion intensity respectively, and
using the first measured ion intensity and a second measured ion intensity to determine a detector calibration factor.

12. A mass spectrometer, comprising a controller according to claim 11.

13. The method according to claim 1, wherein the ion intensity is measured during the wash period and following the wash period.

14. The method according to claim 1, wherein the ion intensity is measured during the wash period.

15. The method according to claim 1, wherein the ion intensity is measured following the wash period.

16. The method according to claim 6, wherein the recovery period has a length of between 2 and 50 seconds.

17. The method according to claim 6, wherein the recovery period has a length of between 5 and 10 seconds.
